(19) United States
(12) Patent Application Publication
(10) Pub. No.: US 2023/0131005 A1
(43) Pub. Date: Apr. 27, 2023

(54) INFORMATION PROCESSOR, IMAGE FORMING APPARATUS, AND CONTROL METHOD

(71) Applicant: SHARP KABUSHIKI KAISHA, Sakai City (JP)

(72) Inventor: HARUNOBU MORI, Sakai City (JP)

(21) Appl. No.: 17/966,686

(22) Filed: Oct. 14, 2022

(30) Foreign Application Priority Data
Oct. 25, 2021 (JP) 2021-173781

(51) Int. Cl. H04L 9/08; G06F 21/60; H04N 1/00; H04N 1/44

(52) U.S. Cl. CPC H04L 9/0894; G06F 21/602; H04N 1/00416; H04N 1/4433; H04N 1/00506

(57) ABSTRACT

An information processor that keeps confidential information existing in an own device, and includes: a storage that saves data and encrypts the data with an encryption key; first non-secure memory for saving the encryption key; second secure memory that can be mounted additionally to save the encryption key; a display that shows various setting menus; an inputter with which a user makes various types of input; and a controller that controls saving of the encryption key and displaying on the display. When an instruction to save the encryption key in the second memory is input to the inputter in a state where the storage is encrypted and the second memory is mounted, the controller saves the encryption key in the second memory.

### BACKGROUND OF THE INVENTION

### Field of the Invention

The present disclosure relates to an information processor and the like.

### Description of the Background Art

In an information processor or a multifunction peripheral (an example of an image forming apparatus) on which an information processor is mounted, information that is encrypted by using an encryption key is stored in a storage (a storage device).

In the related art, it is disclosed that the encryption key is protected at a high security level by saving the encryption key in a secure (safe) device such as a trust platform module (TPM) in the information processor, on which the TPM is mounted, or the like.

However, the TPM is not always mounted as a standard device on the information processor or the multifunction peripheral. Thus, in the case where the device such as the TPM is added later, processing of the encryption key saved in electrically erasable and programmable read only memory (EEPROM), which has already been provided in the information processor or the multifunction peripheral, becomes problematic.

In view of such a circumstance, the present disclosure provides an information processor and the like capable of saving an encryption key safely.

### SUMMARY OF THE INVENTION

The present disclosure is an information processor that keeps confidential information existing in an own device, and includes: a storage that saves data and encrypts the data with an encryption key; first non-secure memory for saving the encryption key; second secure memory that can be mounted additionally to save the encryption key; a display that shows various setting menus; an inputter with which a user makes various types of input; and a controller that controls saving of the encryption key and displaying on the display. When an instruction to save the encryption key in the second memory is input to the inputter in a state where the storage is encrypted and the second memory is mounted, the controller saves the encryption key in the second memory.

The present disclosure is an image forming apparatus on which the information processor is mounted and in which image data is saved in the storage.

The present disclosure is a control method for an information processor that keeps confidential information existing in an own device, and the control method for an information processor includes: saving data in a storage and encrypting the storage with an encryption key; saving the encryption key in first non-secure memory; saving the encryption key in second secure memory that can be mounted additionally; showing various setting menus on a display; making various types of input by a user; and controlling saving of the encryption key and displaying on the display. In the control, when an instruction to save the encryption key in the second memory is input to the inputter in a state where the storage is encrypted and the second memory is mounted, the encryption key is saved in the second memory.

According to the information processor and the like of the present disclosure, it is possible to provide the information processor and the like capable of safely saving the encryption key.

### BRIEF DESCRIPTION OF THE DRAWINGS

FIG. 1 is an overall configuration view of an image forming apparatus on which an information processor according to a first embodiment is mounted.

FIG. 2 is a control block diagram.

FIG. 3 is an explanatory table in which devices used as first memory and second memory are compared.

FIG. 4 is a comparative explanatory table of security states.

FIG. 5 is an explanatory view of a setting menu screen.

FIG. 6 is a control flowchart.

FIG. 7 is a control flowchart of an information processor according to a second embodiment.

FIG. 8 is an explanatory view of a setting menu screen in the second embodiment.

### DESCRIPTION OF THE PREFERRED EMBODIMENTS

A description will hereinafter be made on an embodiment for carrying out the present disclosure with reference to the drawings.

Note that the following embodiments are merely examples for describing the present disclosure, and thus the technical scope of the disclosure stated in the claims is not limited to the following description.

### 1. First Embodiment

### 1.1 Overall Configuration

First, a description will be made on a configuration of an image forming apparatus 10 on which an information processor 200 according to a first embodiment is mounted.

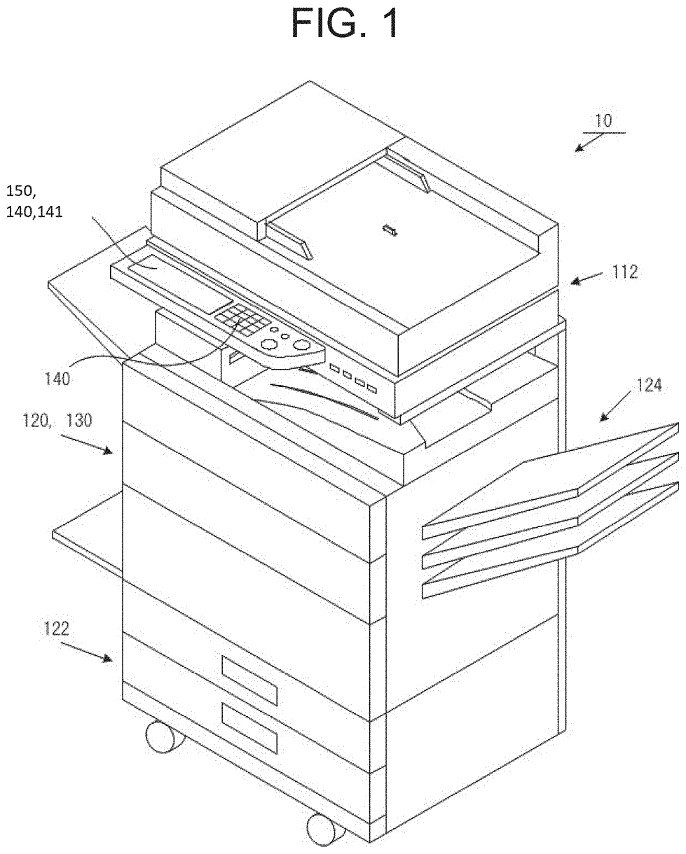

As illustrated in FIG. 1, the image forming apparatus 10 is a multifunction printer (MFP) such as a multifunction peripheral that includes a document reader 112 in an upper portion of the image forming apparatus 10 to read an image of a document and outputs an image by an electrographic method. In the MFP, functions of office equipment such as a copier, a printer, an image scanner, and a facsimile machine are accommodated in a single casing.

As will be described below, the image forming apparatus 10 is the multifunction peripheral in which a storage 162 has an encryption function. In the case where an encryption key is saved in first memory 164 as a non-secure EEPROM storage device, and a menu item for saving the encryption key in second memory 166 as a secure storage device is shown on a display 150, at a time when a user selects the menu item, the encryption key is moved from the first memory 164 to second memory 166, and the menu item on the display 150 is thereafter grayed out or not shown.

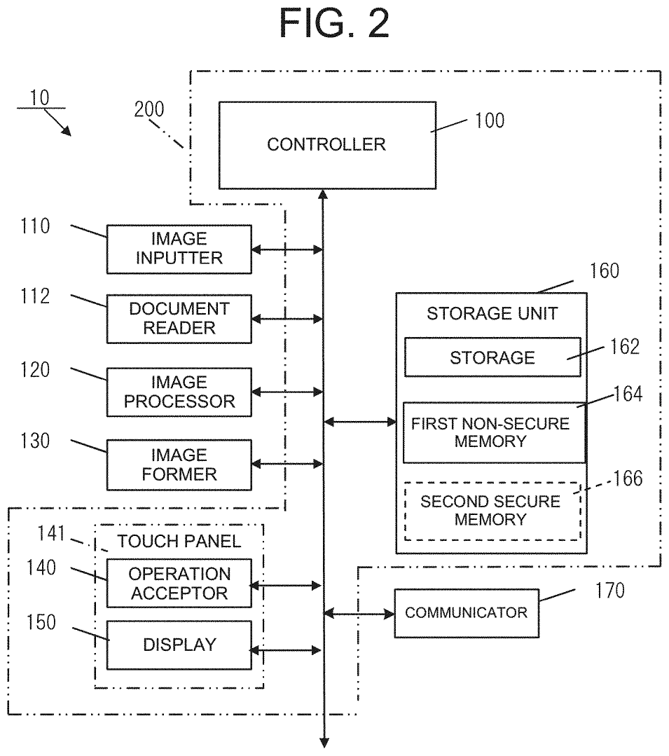

As illustrated in FIG. 2, the image forming apparatus 10 mainly includes a controller 100, an image inputter 110, the document reader 112, an image processor 120, an image former 130, an operation acceptor 140, the display 150, a storage unit 160, and a communicator 170.

The controller 100 is a functional part for controlling the image forming apparatus 10 as a whole.

The controller 100 implements various functions by reading and executing various programs, and is constructed of one or plural arithmetic devices (such as a central processing unit (CPU)) and the like, for example. As will be described below, the storage 162 in the storage unit 160 has a function of being encrypted by using the encryption key. The encryption key is initially saved in the non-secure first memory 164. However, in the case where the secure second memory 166 is additionally installed (additionally mounted) after shipment of the image forming apparatus 10, a function of saving the encryption key in the second memory 166 is exerted by the user's instruction input.

The image inputter 110 is a functional part for inputting image data that is input to the image forming apparatus 10. The image inputter 110 is connected to the document reader 112 that is a functional part for reading the image of the document, and receives the image data output from the document reader 112.

The image inputter 110 may also receive the image data from a storage medium such as USB memory or an SD card. In addition, the image inputter 110 may receive the image data from another terminal device via the communicator 170 that connects the image inputter 110 to the other terminal device.

The document reader 112 has functions of optically reading the document that is placed on contact glass (not illustrated) or the like and passing the read data to the image processor 120.

The image former 130 is a functional part for forming output data, which is based on the image data, on a recording medium (for example, recording paper). For example, as illustrated in FIG. 1, the recording paper is fed from a paper feed cassette 122. Then, after the image is formed on a surface of the recording paper in the image former 130, the recording paper is discharged to a paper discharge tray 124. The image former 130 is constructed of a laser printer using the electrophotographic method, or the like, for example.

The image processor 120 has an image processing function to convert the image data, which has been read by the document reader 112, into the image data in a set file format (TIFF, GIF, JPEG, or the like). Then, an output image is formed on the basis of the image data that has been subjected to the image processing.

The operation acceptor (corresponding to an “inputter”) 140 is a functional part for accepting the user's operation instruction and is constructed of various key switches, a device that detects input by a touch, and the like. The user uses the operation acceptor 140 to input a function to be used and an output condition.

The display 150 is a functional part for showing various types of information to the user and is constructed of a liquid-crystal display (LCD) or the like, for example.

In other words, the operation acceptor 140 provides a user interface for operating the image forming apparatus 10, and various setting menu screens and messages of the image forming apparatus are shown on the display 150.

Here, as illustrated in FIG. 1, as a component of the operation acceptor 140, the image forming apparatus 10 may include a touch panel in which an operation panel 141 and the display 150 are integrally formed. In this case, a method for detecting the input on the touch panel may be a general detection method such as a resistive method, an infrared method, an electromagnetic induction method, or an electrostatic capacitive method.

The storage unit 160 is a functional part for saving (storing), in the storage 162, the various programs including a control program that is required for operation of the image forming apparatus 10, various types of the data including read data, and the data such as user information.

For example, the storage unit 160 is constructed of non-volatile read only memory (ROM), random access memory (RAM), the EEPROM as non-volatile memory, a hard disk drive (HDD), a solid state drive (SSD), and the like. Any of various mass-storage devices such as the HDD and the SSD can be used for the storage 162.

The storage unit 160 has the encryption function for the storage 162 that saves the data. This encryption function encrypts the storage 162 itself with the encryption key so as to take a security measure to protect the internal data. In other words, in the case where this storage function is valid, the data is shown in a decrypted form when the authorized user accesses the storage. On the other hand, the data cannot be decrypted when an unauthorized third party accesses the storage, thus making the storage secure.

In the case where the storage 162 does not have hardware with a data encryption function, the data may be encrypted by the controller 100, and the encrypted data is then written as is into the storage 162. When the data is read out, the data may be decrypted by the controller 100.

The encryption key for the encryption is initially saved in the first memory (corresponding to “first memory”) 164, which is non-secure, non-volatile memory, is constructed of the EEPROM, and is mounted in the image forming apparatus from the time of shipment. Then, in a timely manner after the shipment, the second memory (corresponding to “second memory”) 166, for which a TPM is used to save the encryption key, is additionally mounted to the image forming apparatus, and is structured to be able to save the encryption key by menu selection. A non-secure storage medium other than the EEPROM can be used as the first memory 164. It is needless to say that, in the second memory 166, a TPM chip is preferably used as a secure cryptographic processor that is designed to perform a cryptographic operation, but any of various recording modules, each of which can securely save the encryption key, can be used.

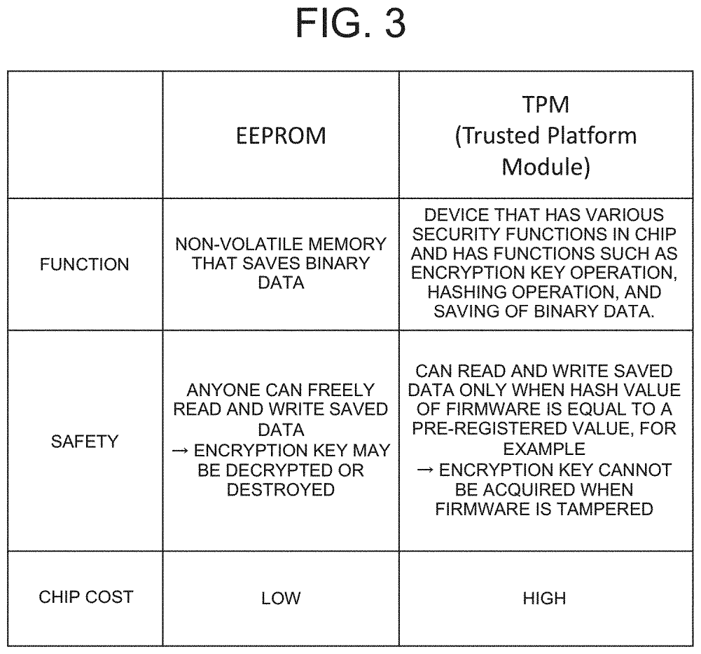

FIG. 3 illustrates comparisons between an EEPROM chip used for the first memory 164 and the TPM chip used for the second memory 166 in terms of functions, safety, and chip cost.

As illustrated in FIG. 3, the EEPROM is a type of the nonvolatile memory, is the ROM capable of electrically rewriting any part at a low frequency, and has a function of the nonvolatile memory to save binary data. The chip thereof is inexpensive and at low cost. However, anyone can read and write the data freely, and the encryption key is possibly decrypted or destroyed. Thus, the safety of the EEPROM is low.

On the other hand, the TPM is a device with various security functions in the chip. Although the chip thereof is expensive, it is possible to read and write the saved data only when a hash value of firmware is equal to a pre-registered value, for example. The encryption key cannot be acquired when firmware thereof is tampered. Thus, the safety of the TPM is high.

The communicator 170 communicates with an external device. A communication interface (communication I/F) that is used to exchange the data is provided as the communicator 170. With the user's operation on the image forming apparatus 10, the communication I/F can send/receive the data, which is stored in the storage unit 160 of the image forming apparatus 10, to/from another computer device connected via a network.

### 1.2 Functional Configuration

As illustrated in a functional block diagram in FIG. 2, an information processor according to the embodiment is the information processor 200 that is mounted on the image forming apparatus 10 and keeps confidential information of the information processor 200 itself.

Storage 162, First Memory 164, and Second memory 166 The information processor 200 includes: the storage 162 that saves various types of the data such as the image data and encrypts the data with the encryption key; the non-secure first memory 164 for saving the encryption key; the secure second memory 166 that can be additionally mounted after the shipment to save the encryption key; the display 150 that shows the various setting menus; the operation acceptor (corresponding to the “inputter”) 140 on which the user makes various types of input; and the controller 100 that controls saving of the encryption key and display of the display 150. When the storage 162 is encrypted and the second memory 166 is mounted in a state where the encryption key is saved in the first memory 164, the controller 100 causes the display 150 to show the setting menu for saving the encryption key in the second memory 166. When an instruction to save the encryption key in the second memory 166 is input to the operation acceptor 140, the controller 100 moves the encryption key, which is saved in the first memory 164, to the second memory 166.

Security State

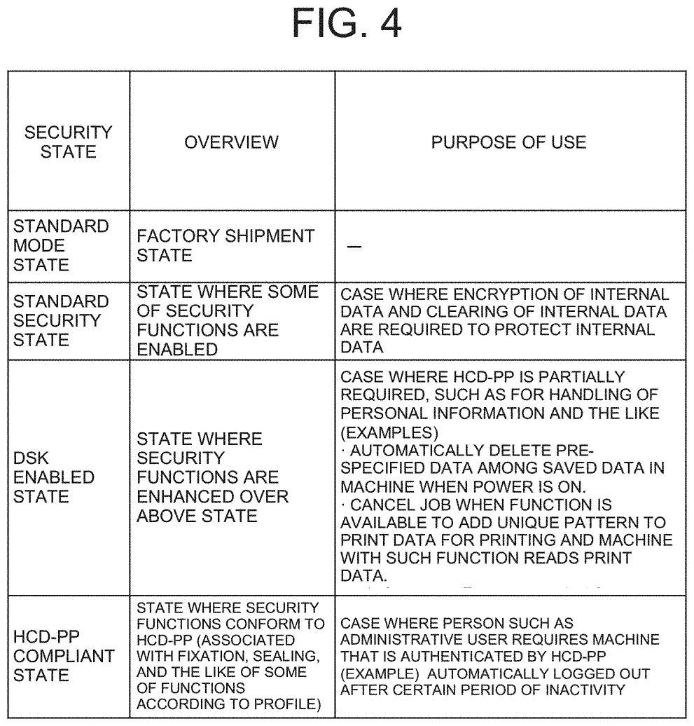

Here, FIG. 4 illustrates an overview and a purpose of use of each security state (a standard mode state, a standard security state, a DSK enabled state, and an HCD-PP compliant state) in the information processor 200.

The “DSK” illustrated in FIG. 4 refers to a data security kit for enhancing a data security function of a MFD (multifunction device: synonymous with the MFP).

The HCD-PP (Protection Profile for Hardcopy Devices: Hardcopy Devices (Digital Multifunction Peripherals) Protection Profile) is a security requirement that is jointly developed by INFORMATION-TECHNOLOGY PROMOTION AGENCY, JAPAN (IPA) and the National Information Assurance Partnership (NIAP), an IT security certification body of the United States government, in cooperation with manufacturers and the like.

Setting Menu Screen

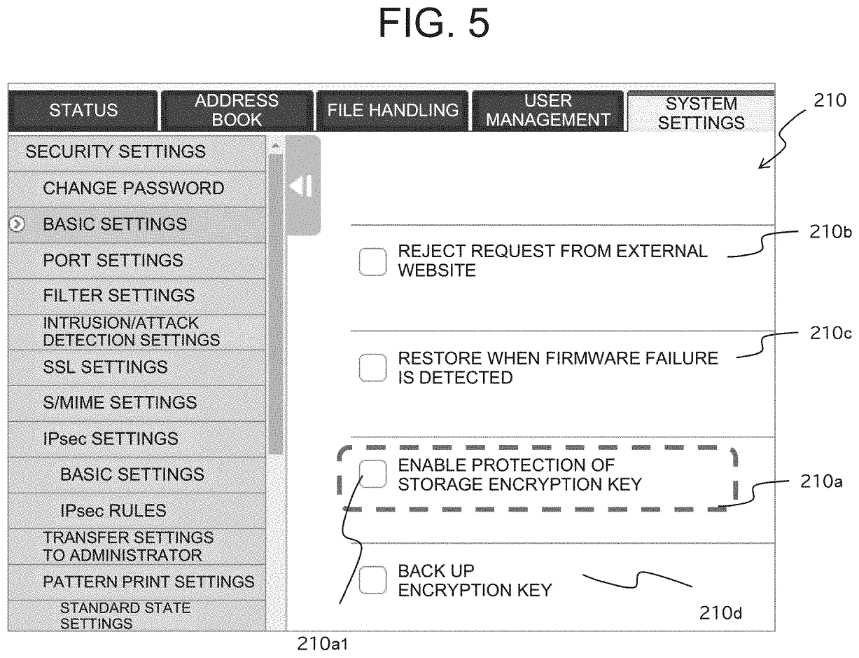

FIG. 5 illustrates an example of a setting menu screen 210 for saving the encryption key in the second memory 166, and the setting menu screen 210 is shown in the display 150 of the operation panel (touch panel) 141.

In this setting menu screen 210, a menu item 210a, “ENABLE PROTECTION OF STORAGE ENCRYPTION KEY”, is shown. When a check box 210a1, which appears with this menu item 210a, is ticked, the setting becomes effective. In addition to the above, a menu item 210b, “REJECT REQUEST FROM EXTERNAL WEBSITE”, a menu item 210c, “RESTORE WHEN FIRMWARE FAILURE IS DETECTED”, a menu item 210d, “BACK UP ENCRYPTION KEY”, and the like are also shown. When a check box, which appears with the respective menu item, is ticked, the selected function becomes effective. It is needless to say that an operation for each of the menu items on the setting menu screen 210 can be accepted and set in a similar manner by input from a switch of the operation acceptor 140 or a terminal other than the operation panel (touch panel) 141.

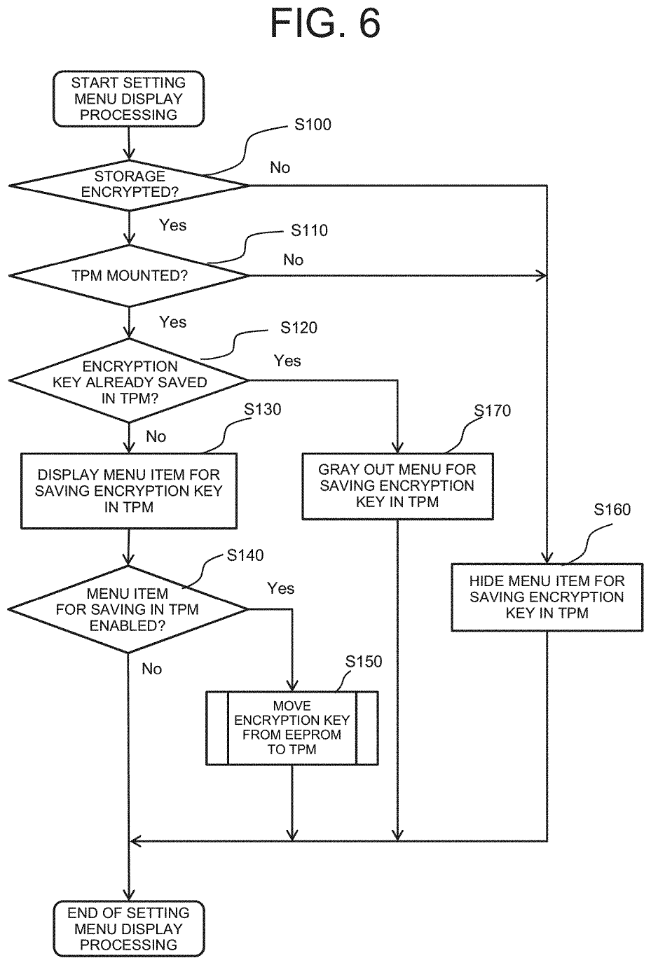

FIG. 6 is a flowchart illustrating a procedure of setting menu display processing that is executed by the controller 100 in the information processor 200 of the embodiment. In the following description and FIG. 6, each of steps 100 onward will be abbreviated as S100.

First, in the image forming apparatus 10 after the shipment, the controller 100 determines whether the information processor 200 has encrypted the storage 162 (S100). In the embodiment, a time of the encryption of the storage 162 is a time when the security state is shifted to the standard security state or the DSK enabled state. At the time of the encryption of the storage 162, the encryption key is also saved in the first memory 164. In this way, even when the encryption key is not saved in memory other than the first memory 164, a place to save the encryption key is secured until the second memory 166 is mounted.

If it is determined in S100 that the storage 162 has not been encrypted (S100: No), the menu item 210a (see FIG. 5) for saving the encryption key in the second memory 166, which is constructed of the TPM, is not shown on the setting menu screen 210 of the display 150 (S160). Thereafter, the setting menu display processing is terminated.

Just as described, by hiding the menu item 210a for saving the encryption key in the second memory 166 in the setting menu screen 210, the user can be notified that the storage 162 is not encrypted. This notification can prompt the user to perform an operation to encrypt the storage 162, for example, or can prompt the user to perform an appropriate next operation by recognizing a possible defect in the storage 162, or the like.

On the other hand, if it is determined in S100 that storage 162 has been encrypted (S100: Yes), it is determined whether the second memory (TPM) 166 has been mounted on the information processor 200 (S110).

If it is determined that the second memory 166 has already been mounted on the information processor 200 (S110: Yes), it is determined whether the encryption key has already been saved in the second memory 166 (S120).

If it is determined that the encryption key has not already been saved in the second memory 166 (S120: No), the menu item 210a for saving the encryption key in the second memory 166 (“ENABLE PROTECTION OF STORAGE ENCRYPTION KEY” in FIG. 5) is shown on the setting menu screen 210 of the display 150 (S130). From what have been described so far, in the state where the storage 162 is encrypted and the encryption key is saved in the first memory 164, which is constructed of the EEPROM, the setting menu for saving the encryption key in the second memory 166, which is constructed of the TPM, is shown.

Next, it is determined whether the menu item 210a for saving the encryption key in the second memory (TPM) 166 has been enabled (S140). If it is determined that the menu item 210a has not been enabled (S140: No), the setting menu display processing is terminated.

On the other hand, if it is determined that the menu item 210a for saving the encryption key in the second memory (TPM) 166 has been enabled (S140: Yes), the encryption key is moved from the first memory (EEPROM) 164 to the second memory (TPM) 166 (S150). When the setting menu for the menu item 210a is enabled, the encryption key is moved from the first memory 164 to the second memory 166.

When the encryption key saved in the first memory 164 is moved to the second memory 166, processing to delete the encryption key saved in the first memory 164 is executed. In this way, a state in which the encryption key saved in the second memory 166 remains to be saved in the non-secure first memory 164 can reliably be eliminated, and a low security state can be eliminated as quickly as possible.

If it is determined in S110 that the second memory 166 has not been mounted on the information processor 200 (S110: No), the processing proceeds to S160. In S160, on the setting menu screen 210, the menu item 210a for saving the encryption key in the second memory 166 is hidden. By this processing in S160, even when the storage 162 is encrypted, the operation to save the encryption key in the second memory 166 cannot be performed or is difficult to be performed due to a fact that the menu item 210a is not shown. In this way, it is possible to notify the user that the encryption of the storage 162 is incomplete. The notification can prompt the user to mount the second memory 166.

If it is determined in S120 that the encryption key has already been saved in the second memory 166 (S120: Yes), the processing proceeds to S170. In S170, on the setting menu screen 210, display processing (gray-out processing) is executed to cover the menu item 210a for saving the encryption key in the second memory 166 with gray display. Thereafter, the setting menu display processing is terminated. After the processing in S140, S150, S160, and S170 is terminated, the processing returns to the start and stands by until a next operation is input.

The above-described gray-out processing causes the menu item 210a to be displayed differently than usual, and thus can notify and alert the user that the encryption key has already been saved in the second memory 166. In addition to the gray-out processing, for example, a specific display, “TPM IN USE”, can be provided.

As described above, in the state where the storage 162 is encrypted and the encryption key is saved in the second memory 166, the specific display is provided on the setting menu screen. In this way, the user can be notified by the specific display that a secure state is established. Any of various specific displays other than “TPM IN USE” can be provided.

A setting menu for returning the encryption key, which is saved in the second memory 166 to the first memory 164, is unavailable. In this case, such a display is provided that the encryption key cannot be returned to the first memory 164 before being moved to the second memory 166. For example, “ENCRYPTION KEY SAVED IN TPM CANNOT BE RETURNED TO EEPROM” is displayed.

In this way, after the encryption key is saved in the second memory 166 in a secure state, the secure state can be maintained, and the security state can thereby be enhanced.

The controller 100 may back up and save the encryption key, which is saved in the second memory, in third memory (a storage unit). The third memory is constructed of USB memory that can be attached to/detached from the information processor 200. In this case, showing the setting menu on the display is highly convenient and thus is preferred.

### 2. Second Embodiment

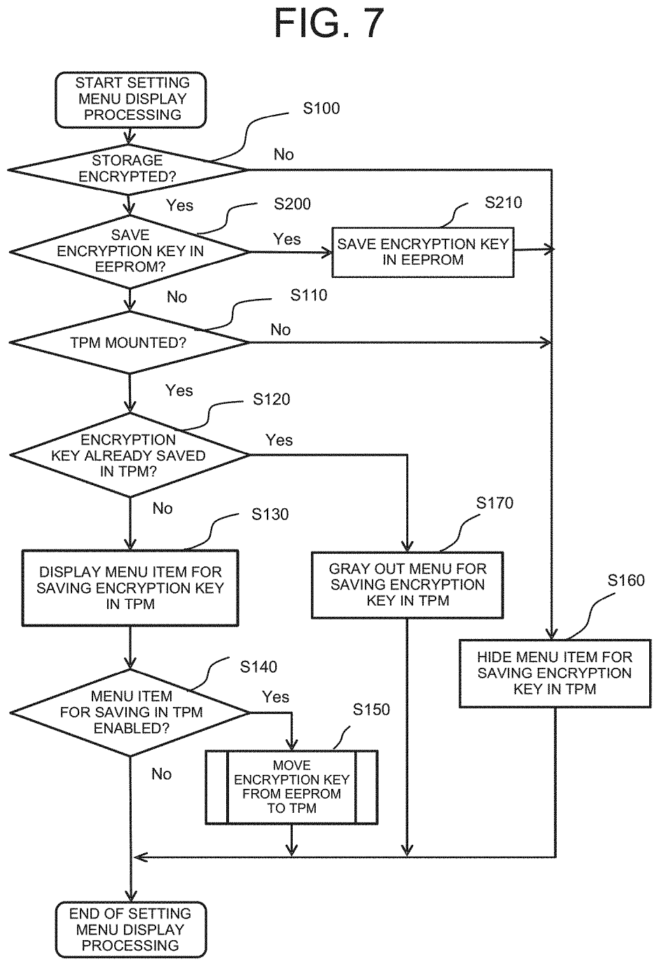

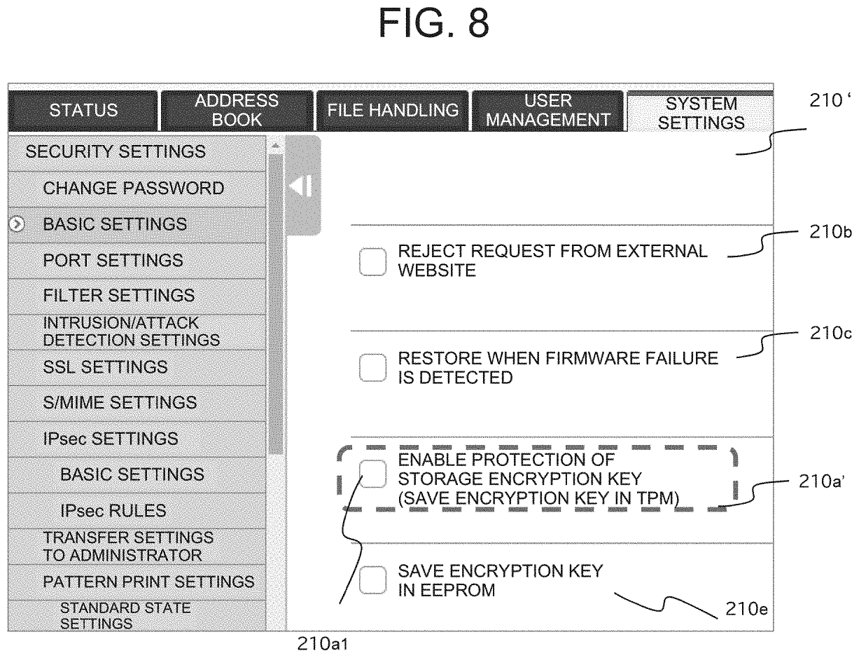

FIG. 7 is a flowchart of an information processor according to a second embodiment. FIG. 8 illustrates a setting menu screen 210′ in the second embodiment.

In the second embodiment illustrated in FIG. 7, at the time of the encryption of the storage 162, the encryption key can selectively be saved in the first memory 164 or the second memory 166. The same steps as those in FIG. 6 are denoted by the same step numbers.

As a part by which the second embodiment differs from the first embodiment, as illustrated in FIG. 7, when it is determined that the storage 162 has been encrypted (S100: Yes), it is determined whether to save the encryption key in the first memory 164, which is constructed of the EEPROM (S200).

More specifically, as illustrated in FIG. 8, a menu item 210e (“SAVE ENCRYPTION KEY IN EEPROM” in FIG. 8) is shown on the setting menu screen 210′ of the display 150, and it is determined whether a setting of the menu item 210e has been enabled by the user. If it is determined that the setting of the menu item 210e has been enabled and the encryption key is to be saved in the first memory 164, the encryption key is saved in the first memory 164 (S210), and the processing proceeds to S160.

On the other hand, if it is determined in S200 that the encryption key is not saved in the first memory 164, the processing proceeds to S110, and subsequent processing is executed.

In the second embodiment, the encryption key can be saved in the first memory 164 made of non-secure EEPROM in the case where there is no problem that the encryption key remains to be saved in the first memory 164, or in the state where the second memory 166 is not mounted. Thus, the second embodiment is highly convenient. Meanwhile, when it is desired to save the encryption key in the secure TPM, it is possible to select saving of the encryption key in the second memory 166, which is constructed of the TPM, which is highly convenient.

As illustrated in FIG. 8, the menu item 210a′, which is used to determine whether to save the encryption key in the second memory 166, and the menu item 210e, which is used to determine whether to save the encryption key in the first memory 164 (EEPROM), are shown in the setting menu screen 210 of the display 150. However, the present disclosure is not limited thereto, and only the menu item 210e may be shown.

In addition to the first embodiment and the second embodiment, various other modifications can be made.

For example, in the second embodiment, the processing in S200 can appropriately be set such as being executed between S110 and S120.

The description has been made so far on the embodiments. However, the specific configurations are not limited to those in the embodiments, and design and the like that do not depart from the gist of the present disclosure also fall within the scope of the claims.

In the embodiments, the program that can be operated in each of the devices is a program for controlling the CPU and the like to implement the functions in the above-described the embodiments (the program that causes a computer to function). The information handled by these devices is temporarily stored in a transitory storage device (for example, the RAM) during processing thereof, is then stored in the storage device such as any of various types of the ROM or the HDD, and is read, modified, or written by the CPU when necessary.

Here, the recording medium for storing the program may be any non-transitory recording medium such as a semiconductor medium (for example, the ROM, a non-volatile memory card, or the like), an optical recording medium/magnetooptical recording medium (for example, a digital versatile disc (DVD), a magnetooptical disc (MO), a mini disc (MD), a compact disc (CD), a Blue-ray® disc (BD), or the like), and a magnetic recording media (for example, a magnetic tape, a flexible disk, or the like).

The functions according to the above-described embodiment may be implemented not only by executing the loaded program. The functions according to the present disclosure may be implemented by joint processing with an operating system, another application program, or the like on the basis of an instruction of the program.

When the program is distributed in the market, the program can be distributed by storing the program in a portable storage device, or can be transferred to a server computer that is connected via the network such as the Internet. It is needless to say that, in this case, the storage device of the server computer is included in the present disclosure.

Each of the devices in the above-described embodiment may partially or entirely be implemented as Large Scale Integration (LSI) that is typically an integrated circuit. Each functional block of each of the devices may individually be formed as a chip, or may partially or entirely be integrated into a chip. An integrated circuit method is not limited to the LSI, but can be realized by a dedicated circuit or a general-purpose processor. In addition, when the progress of the semiconductor technology can replace the LSI with a new technology of the integrated circuits, it is needless to say that it is possible to use such a new technology for the present disclosure.

What is claimed is:

1. An information processor that keeps confidential information existing in an own device, the information processor comprising:
a storage that saves data and is encrypted with an encryption key;
first non-secure memory for saving the encryption key;
second secure memory that can be mounted additionally to save the encryption key;
a display that shows various setting menus;
an inputter with which a user makes various types of input; and
a controller that controls saving of the encryption key and displaying on the display, wherein
when an instruction to save the encryption key in the second memory is input to the inputter in a state where the storage is encrypted and the second memory is mounted, the controller saves the encryption key in the second memory.

2. The information processor according to claim 1, wherein
the controller causes the display to show a setting menu for saving the encryption key in the second memory when the storage is encrypted and the second memory is mounted in a state where the encryption key is saved in the first memory, and the controller moves the encryption key saved in the first memory to the second memory when the instruction to save the encryption key in the second memory is input to the inputter.

3. The information processor according to claim 1, wherein
when the storage is not encrypted, the controller does not cause the display to show a setting menu for moving the encryption key to the second memory.

4. The information processor according to claim 1, wherein
the controller saves the encryption key in the first memory at the time of encryption of the storage.

5. The information processor according to claim 1, wherein
the controller can selectively save the encryption key in the first memory or the second memory at the time of encryption of the storage.

6. The information processor according to claim 2, wherein
the controller deletes the encryption key saved in the first memory when moving the encryption key saved in the first memory to the second memory.

7. The information processor according to claim 1, wherein
in a state where the storage is encrypted and the encryption key is saved the second memory, the controller provides a specific display in the setting menus.

8. The information processor according to claim 2, wherein
after moving the encryption key that is saved in the first memory to the second memory, the controller prevents retuning of the encryption key to the first memory.

9. The information processor according to claim 1, wherein
the controller causes the display to show a setting menu for backing up and saving the encryption key, which is saved in the second memory, in third memory attachable to and detachable from the information processor.

10. An image forming apparatus on which the information processor according to claim 1 is mounted and in which image data is saved in the storage.

11. A control method for an information processor that keeps confidential information existing in an own device, the control method for an information processor comprising:
saving data in a storage and encrypting the storage with an encryption key;
saving the encryption key in first non-secure memory;
saving the encryption key in second secure memory that can be mounted additionally;
showing various setting menus on a display;
making various types of input by a user; and
controlling saving of the encryption key and displaying on the display, wherein
in the control, when an instruction to save the encryption key in the second memory is input to the inputter in a state where the storage is encrypted and the second memory is mounted, the encryption key is saved in the second memory.
